(19) United States
(12) Patent Application Publication
(10) Pub. No.: US 2007/0033307 A1
(43) Pub. Date: Feb. 8, 2007

(54) USB dual-interface personal disk

(75) Inventor: Shih-Tsung Yu, Banchiau City (TW)

Correspondence Address: TROXELL LAW OFFICE PLLC, SUITE 1404, 5205 LEESBURG PIKE, FALLS CHURCH, VA, 22041, US

(73) Assignees: Shih-Tsung Yu; Great Precision Co., Ltd.

(21) Appl. No.: 11/198,272

(22) Filed: Aug. 8, 2005

(51) Int. Cl. G06F 13/38

(52) U.S. Cl. 710/62

(57) ABSTRACT

A USB dual-interface personal disk specifically the USB interface module for accessing data between a computer and its periphery equipment includes a standard USB interface and a Mini USB interface, and is composed of a USB control chip combining with a single or a plurality of flash memory chips.

### BACKGROUND OF THE INVENTION

(a) Field of the Invention

The present invention relates to a USB (Universal Serial Bus) dual-interface personal disk, and more particularly to a USB dual-interface personal disk for storing and accessing data.

(b) Description of the Prior Art

As the continuous advancement of technology, related electronic information products such as personal computers, MP3 , digital cameras/camcorders have become extremely popular, whereas the requirement of using these multimedia products as devices of digital storage by a consumer has gradually increased. However, according to the variation of products to be applied, these kinds of storage devices also have different specifications and sizes.

In the existing market, the USB interface has almost become a standard interface for the computer and periphery equipment; a function of applying anywhere can be almost achieved by choosing a USB personal disk (or the so called thumb disk). Furthermore, as the USB interface is also provided with the characteristics of plug-and-play and hot swap, it can save a trouble of installing a driver repeatedly for a user. In addition, this kind of storage device is compact and easy to carry, and uses flash memories to achieve an effect of data storage and access in a high capacity, thereby gradually replacing a conventional soft or hard disk with a large size.

However, as a personal disk 100 with a single transmission interface (as shown in FIG. 3) can only perform data transmission for an interface with a single specification (such as a standard USB interface 200) and cannot be applied to interfaces with other formats and specifications, thereby causing an inconvenience in application. Although there are vendors in the market who combine the USB interface with a CF (Compact Flash) transmission interface (a 50 pin CF card) to try to achieve a data storage by using a dual-interface, such as the Taiwan Utility Patent No. 572284 and 551552, as the CF interface is only specifically used for the CF card and cannot be commonly applied to the existing popular USB interface, which is still not perfect.

The popular built-in USB interfaces in computer periphery equipment include the standard versions of 1.1, 2.0, and the Mini USB series. However, as the existing digital device is usually provided with one transmission interface, therefore a trouble of unable to use due to an unconformity of specification often occurs.

### SUMMARY OF THE INVENTION

The primary object of the present invention is to provide a memory stick having both a standard USB interface and a Mini USB interface, for a user who requires using a product of dual-interface specification.

Accordingly, the USB dual-interface personal disk of the present invention utilizes a USB control chip to combine with a single or a plurality of flash memory chips, and a circuit design of the USB control chip is in a parallel method for separating junctions of the standard type and the Mini USB type.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a flow diagram of an implementation of the present invention.

FIG. 2 shows a schematic view of structure of an implementation of the present invention.

FIG. 3 shows a schematic view of structure of a conventional personal disk.

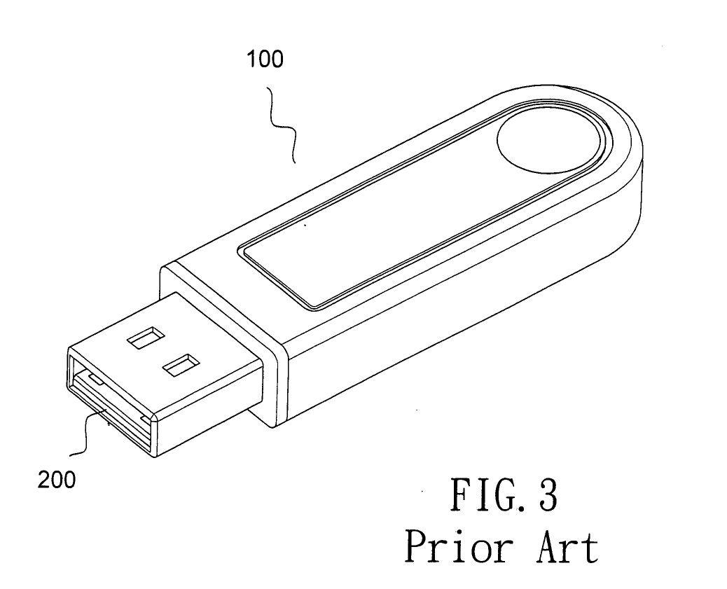

### DETAILED DESCRIPTION OF THE PREFERRED EMBODIMENTS

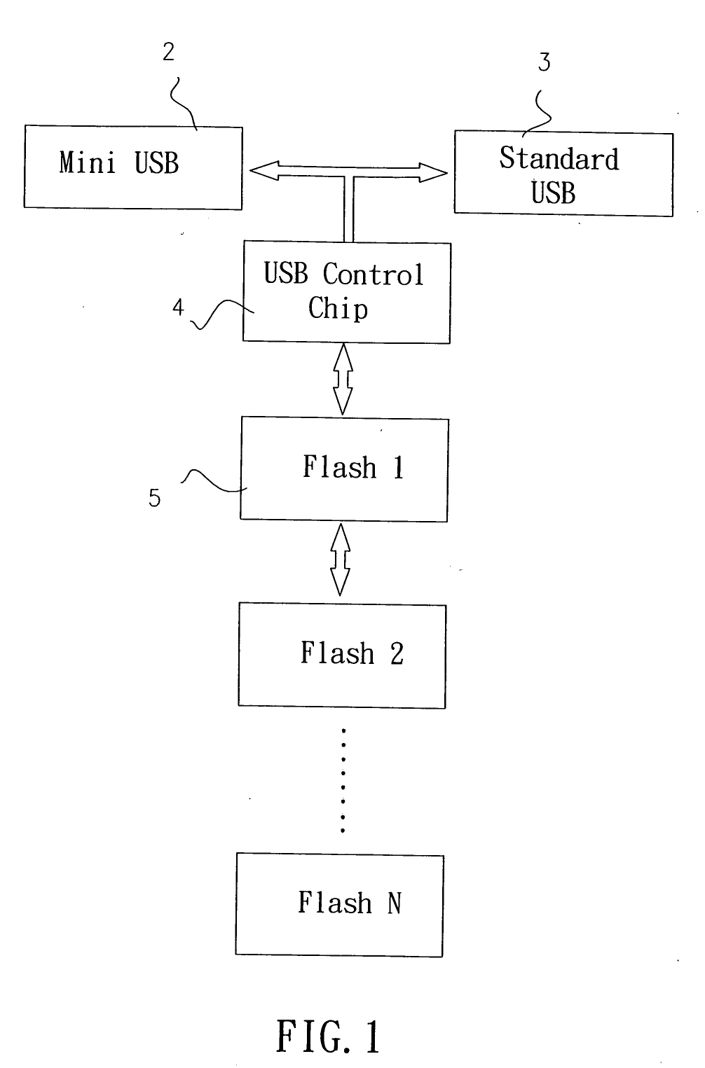

Referring to FIG. 1, along with other drawings, the present invention includes a standard USB 1 and a Mini USB 2 interfaces, and the aforementioned two interfaces are combined with a single or a plurality of flash memory chips 5 by a USB control chip 4. By a means of non-volatility and easiness to be erased and written of the flash memory chips 5, files of all kinds of specifications such as video clips, digital pictures, MP3 music, and game data can be stored and accessed in a large quantity and quickly. In addition, the access and deletion of memories can be controlled with the USB control chip 4.

On the other hand, as the standard USB 1 and the Mini USB 2 interfaces are combined with the USB control chip 4 in a parallel method, one interface will be still functioning in case of a damage to, the other interface.

Due to a provision of the dual-interface of the standard USB 1 and the Mini USB 2, the present invention is consistent with a requirement of interface of a personal computer, a notebook computer, and their periphery equipment in the existing market, and is compatible with all kinds of operating platforms. Moreover, as the USB interface is also provided with the features of plug-and-play and hot swap, the present invention provides a lot of convenience to a user.

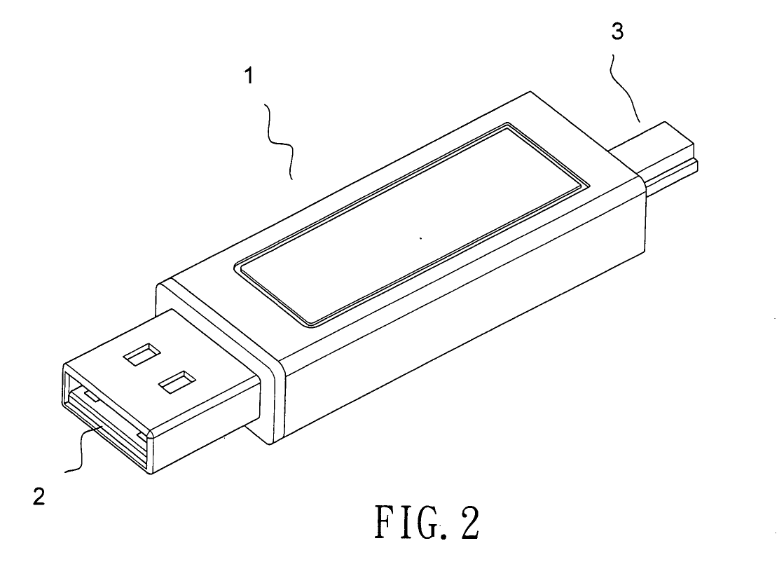

Referring to FIG. 2, it shows a schematic view of an implementation of the present invention, wherein a standard USB 2 and a Mini USB 3 interfaces are installed at two ends of a personal disk 1, respectively. Nevertheless, the USB 2 and the Mini USB 3 interfaces can also be mounted at a same side or edge, including a front and a rear end, a left and a right end, or a same end, etc.

Accordingly, the USB dual-interface personal disk of the present invention is really provided with a USB interface and a Mini USB interface for accessing data on transmission interfaces with various specifications and can be employed by related industries.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An USB dual-interface personal disk wherein the USB interface is a standard type and the other interface is a Mini USB interface.

2. The USB dual-interface personal disk according to claim 1, wherein a circuit for controlling the dual-interface is composed of an USB control chip combining with a single or a plurality of flash memory chips.

3. The USB dual-interface personal disk according to claim 1, wherein the dual-interface of standard USB and Mini USB is in a parallel design, and is connected to the USB control chip.

4. The USB dual-interface personal disk according to claim 1, wherein the standard USB interface and the Mini USB interface are installed at two ends of the personal disk, respectively.

5. The USB dual-interface personal disk according to claim 1, wherein the standard USB interface and the Mini USB interface are installed at a same end of the personal disk.

6. The USB dual-interface personal disk according to claim 1, wherein the standard USB interface and the Mini USB interface are installed at a same side of the personal disk.

7. The USB dual-interface personal disk according to claim 1, wherein the standard USB interface and the Mini USB interface are installed at different sides of the personal disk.
